(19) United States
(12) Patent Application Publication
(10) Pub. No.: US 2013/0212205 A1
(43) Pub. Date: Aug. 15, 2013

(54) TRUE GEO-REDUNDANT HOT-STANDBY SERVER ARCHITECTURE

(71) Applicants: Andrew D. Flockhart, Thornton, CO (US); Joylee Kohler, Northglenn, CO (US); Robert C. Steiner, Broomfield, CO (US)

(72) Inventors: Andrew D. Flockhart, Thornton, CO (US); Joylee Kohler, Northglenn, CO (US); Robert C. Steiner, Broomfield, CO (US)

(73) Assignee: AVAYA INC., Basking Ridge, NJ (US)

(21) Appl. No.: 13/396,436

(22) Filed: Feb. 14, 2012

(51) Int. Cl. G06F 15/16

(52) U.S. Cl. 709/208; 709/248

(57) ABSTRACT

A server configuration provides a geo-redundant server that is ready as a hot-standby to the primary server in another location. This architecture can be easily implemented in a distributed contact center environment or any other server deployment where services provided by the primary server are mission-critical. One exemplary configuration provides a single active master server. This single active master server is responsible for making all service-based decisions, receiving and processing client requests, etc., as long as it is operational. A second server is provided at the same geographic site or location as the single active master and a high bandwidth active LAN connection is established between the two. The second server maintains synchronization with the single active master. The second server is also connected with a third server via a WAN. The second server provides the third server with the state information for synchronization with the single active master.

### BACKGROUND

High Availability (HA) protection and redundancy is typically provided for mission-critical, very important or high demand architectures, systems or enterprises.

High-availability clusters (also known as HA clusters or failover clusters) are groups of computers or servers that support server applications that can be reliably utilized with a minimum of down-time. They operate by harnessing redundant computers in groups or clusters that provide continued service when one system component(s) fails.

Without clustering, if a server running a particular application crashes, the application will be unavailable until the crashed server is fixed. HA clustering remedies this situation by detecting hardware/software faults, and immediately restarting the application on another system without requiring administrative intervention, a process known as failover. As part of this process, clustering software may configure the node before starting the application on it. For example, appropriate file systems may need to be imported and mounted, network hardware may have to be configured, and some supporting applications may need to be running as well.

HA clusters are often used for critical databases, file sharing on a network, business applications, and customer services such as electronic commerce websites and call centers.

HA cluster implementations attempt to build redundancy into a cluster to eliminate single points of failure, including multiple network connections and data storage which is redundantly connected via storage area networks.

HA clusters usually use a heartbeat private network connection which is used to monitor the health and status of each node in the cluster. One subtle but serious condition all clustering software must be able to handle is split-brain. Split-brain occurs when all of the private links go down simultaneously, but the cluster nodes are still running. If that happens, each node in the cluster may mistakenly decide that every other node has gone down and attempt to start services that other nodes are still running. Having duplicate instances of services may cause data corruption on the shared storage.

High Availability protection can also be provided for an executing virtual machine. A standby server provides a disk buffer that stores disk writes associated with a virtual machine executing on an active server. At a checkpoint in the HA process, the active server suspends the virtual machine; the standby server creates a checkpoint barrier at the last disk write received in the disk buffer; and the active server copies dirty memory pages to a buffer. After the completion of these steps, the active server resumes execution of the virtual machine; the buffered dirty memory pages are sent to and stored by the standby server. Then, the standby server flushes the disk writes up to the checkpoint barrier into disk storage and writes newly received disk writes into the disk buffer after the checkpoint barrier.

Replication of software applications using state-of-the-art Virtual Machine (VM) platforms and technologies is a very powerful and flexible way of providing high availability guarantees to software application users. Application vendors can take advantage of VM technology to build reliability into their solutions by creating multiple images (or copies) of the software application running synchronously, but independently of one another. These images can run on the same physical device, e.g., a general purpose application server, or within multiple, decoupled VM containers, or they can be developed across multiple physical computers in decoupled VM containers. Multiple VM replications schemes exists, but in general, VM solutions have a primary software image that delivers software services for users and then a secondary or tertiary backup image at a standby server that can take over for the primary in the event of a failure. The backup images are generally synchronized at discrete time intervals to update the data structures and database of the backup servers to track changes that have taken place since the last time the data synchronization update took place. The synchronization is referred to as “commit” and these solutions provide dramatic improvements in the ability for a software application vendor to guarantee that its users will receive reliable access to the software application services.

In high availability environments, a primary (active) and secondary (passive) system work together to ensure synchronization of states either in tight lock step, such as tandem and stratus fault-tolerant systems, or loose-lock step, such as the less expensive clusters. Whenever there is a state change at some level of the system, the primary sends the summary state to the secondary which adjusts its state to synchronize with the primary using the summary state. When the primary fails before being able to transmit any information it has accumulated since the last checkpointing, that information is usually locally replayed by the secondary based on the date it is received and tries to synchronize itself before taking over as primary.

### SUMMARY

The need for geo-redundancy in contact centers and other architectures employing mission-critical services is increasing. Highly-available geo-redundant systems are specifically desirable, but often difficult to implement successfully, or at least cost-effectively as discussed above.

As illustrated herein, one exemplary embodiment is directed toward a server architecture that provides a geo-redundant server that is ready as a hot-standby to the primary server in another location. This architecture can be easily implemented in a distributed contact center environment or any other server deployment where services provided by the primary server are mission-critical.

In accordance with one exemplary monument, the configuration provides a single active master server. This single active master server is responsible for making all service-based decisions, receiving and processing client requests, etc., as long as it is operational. A second server is provided at the same geographic site or location as the single active master and a high bandwidth active LAN connection is established between the two. The second server maintains synchronization with the single active master (e.g., receives all state information that the single active server receives, but does not act on such information). The second server is also connected with a third server (at a remote geographic site or location) via a high-bandwidth WAN. The second server provides the third server with the state information needed to maintain synchronization with the single active master. The third server may also be connected to a fourth server (also at the remote site) via a high bandwidth LAN. All other connections between servers may optionally be low-bandwidth connections used for passive heart-beats to maintain the health of the system and provide quick switching if a primary WAN link fails.

In a contact center type of implementation, the servers may correspond to work assignment engines or other computational resource(s).

Another exemplary aspect utilizes mechanisms for compressing data for sharing the status or resources. Specifically, the status of resources can be shared by a bit vector. If the data is compressed, then it is possible to get the status of, for example, 50,000 agents, in a single packet of data. Work status or changes to entities like skillsets can be conveyed in four bytes of data where the first three bytes provide the Work ID and the last byte includes the status information. Skillset metrics can be updated in, for example, four-byte blocks as well. The first two bytes may provide the Skill ID, the third byte may provide the metric and the fourth byte may provide a value. Metrics that are floating point and can't be enumerated or normalized to one byte can be sent in a large metric frame. This may result in a lossy metric transfer (some resolution will be lost for a value), but enough data may still be transferred to facilitate failover conditions.

As briefly mentioned above, prior solutions only suggest active-active or active-passive high availability system configurations. In accordance with one exemplary embodiment, two servers at one site are provided, where one is primary and active and the other is responsible for maintaining synchronization with the primary server and providing synchronization data to another server located at a remote site.

Accordingly, an exemplary aspect is directed toward a true geo-redundant and hot-standby server architecture which utilizes intelligent compression algorithms to share data between servers at different sites.

Other prior solutions typically require high-bandwidth connections, restricted to LANs because of performance considerations. Moreover, prior solutions require modification of the operating system or access to interrupts and page faults and the ability to restart on an instruction. These solutions also use large amounts of CPU processing power at only 150,000 calls per hour which translates to a maximum of less than 300,000 calls per hour using 60% of the processor resources for duplication. These solutions also assign all data shares the same priority in the queue, i.e., memory access order. Also, when call management servers are separated across a WAN, only administrative state is replicated.

In accordance with an exemplary embodiment discussed herein, the architecture uses the standby (2) and (3) servers or engines on each site to offload the compression and protocol off the main server (1) and its full backup (4) (See FIG. 1).

In accordance with another exemplary embodiment, the architecture vectorizes the data into frames that can easily be compressed (for example by 10 times or better using simple run-length encoding) not simple difference updates. Frames can be scheduled to meet the freshness requirements of the data between server 1 and server 4 and this is all able to be accomplished utilizing low-bandwidth connections over a WAN with multiple backups being possible. Furthermore, an additional exemplary advantage to this particular configuration is that no changes are required to the operating system, and it is a simple model using attributed data in computer-controlled applications to mark age, volitility, and freshness requirements.

An additional aspect and advantage is that the architecture can easily accommodate one million calls per hour at, for example, 10% CPU burden on the main (active) server, which is 200 times more efficient that prior solutions. Moreover, all state information can be replicated over the WAN, not just administrative data, allowing continued operation of in-flight processing.

The architecture also has the exemplary advantage of distributing the workload on to the standby servers (2) and server (3), thus offloading the primary servers 1 and 4 of these tasks. Failover is geo-redundant with, for example, two servers at each site, with the failover order being 1-2-3-4.

In accordance of another exemplary advantage, data attributes define what will be shared not “memory pages” as in prior solutions. Data share rates do not need FIFO queuing, but can be requirement driven, such as volatile critical data going before non-critical data. The servers can each play different asymmetrical roles, whereas in prior solutions the active and standby both process all the data. Moreover, another exemplary advantage is that failover across the servers provides a second level of protection in failing over from server 1 to server 3 or server 4, when server 2 fails. Prior solutions are unable to perform in this manner.

In accordance with another exemplary embodiment, there are at least two geo-redundant sites, four servers, where server 1 is the primary, server 2 is site A hot-standby, site B is following site A, with server 4 as the primary for site B, that are all connected by various combinations of LANs/WANs. In accordance with one exemplary embodiment, all servers can be connected and switched to and from primary and alternate network paths.

In accordance with another exemplary embodiment, and due to the bandwidth efficiency of the architecture disclosed herein, geo-redundancy across a WAN becomes practical. This allows, for example, all state information can be replicated across the WAN.

In accordance with another exemplary embodiment, synchronization frames are built that represent the “meaning” of the objects and schedule the transmission of those frames based on change rates and synchronization issues using cache-conscious processing. This exemplary solution is designed for geo-redundancy, not just a local redundancy, high-bandwidth standby. The exemplary embodiment can operate in the low-megabit ranges ( 1/100 the bandwidth of the prior solutions). This exemplary solution is designed to keep four servers in synch and use the secondary servers on each end to handle synchronization load instead of the primary server, thus solving the biggest problem with software duplication in Communications Manager (CM)—the primary server's processor time impact.

The techniques described herein can provide a number of advantages depending on the particular configuration. The above and other advantages will be apparent from the disclosure contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material.”

The term “computer-readable medium” as used herein refers to any tangible, non-transitory storage and/or transmission medium(s) that participate in providing instructions to a processor(s)/computer(s) for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like.

While circuit or packet-switched types of communications can be used with the present system, the concepts and techniques disclosed herein are applicable to other protocols.

Accordingly, the disclosure is considered to include a tangible storage medium or distribution medium and prior art-recognized equivalents and successor media, in which the software implementations of the present technology are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the technology is described in terms of exemplary embodiments, it should be appreciated that individual aspects of the technology can be separately claimed.

The preceding is a simplified summary of the technology to provide an understanding of some aspects thereof. This summary is neither an extensive nor exhaustive overview of the technology and its various embodiments. It is intended neither to identify key or critical elements of the technology nor to delineate the scope of the technology but to present selected concepts of the technology in a simplified form as an introduction to the more detailed description presented below. As will be appreciated, other embodiments of the technology are possible utilizing, alone or in combination, one or more of the features set forth above or described in detail below.

### BRIEF DESCRIPTION OF THE DRAWINGS

FIG. 1 illustrates an exemplary geo-redundant hot-standby server architecture according to an embodiment of this invention.

FIG. 2 illustrates exemplary data stream processor according to this invention.

FIG. 3 illustrates an exemplary data structure.

FIG. 4 illustrates an exemplary work status data structure.

FIG. 5 illustrates an exemplary skillset and metric data structure.

FIG. 6 illustrates an exemplary metric data structure.

FIG. 7 is a flowchart illustrating an exemplary method for failover.

FIG. 8 illustrates an exemplary method for operation of a geo-redundant system upon a preparation of the primary location and a secondary location.

### DETAILED DESCRIPTION

The exemplary systems and methods will also be described in relation to software, modules, and associated hardware and network(s). In order to avoid unnecessarily obscuring the present disclosure, the following description omits well-known structures, components and devices that may be shown in block diagram form, are well known, or are otherwise summarized.

For purposes of explanation, numerous details are set forth in order to provide a thorough understanding of the present technology. It should be appreciated however, that the technology may be practiced in a variety of ways beyond the specific details set forth herein.

A number of variations and modifications can be used. It would be possible to provide or claim some features of the technology without providing or claiming others.

The exemplary systems and methods will be described in relation to system failover improvements. However, to avoid unnecessarily obscuring the present disclosure, the description omits a number of known structures and devices. This omission is not to be construed as a limitation of the scope of the claims. Specific details are set forth to provide an understanding of the present technology. It should however be appreciated that the technology may be practiced in a variety of ways beyond the specific detail set forth herein.

Furthermore, while the exemplary embodiments illustrated herein show various components of the system collocated; certain components of the system can be located remotely, at distant portions of a distributed network, such as a LAN or WAN, cable network, InfiniBand network, and/or the Internet, or within a dedicated system. Thus, it should be appreciated, that the components of the system can be combined in to one or more devices, such as a gateway, or collocated on a particular node of a distributed network, such as an analog and/or digital communications network, a packet-switch network, a circuit-switched network or a cable network.

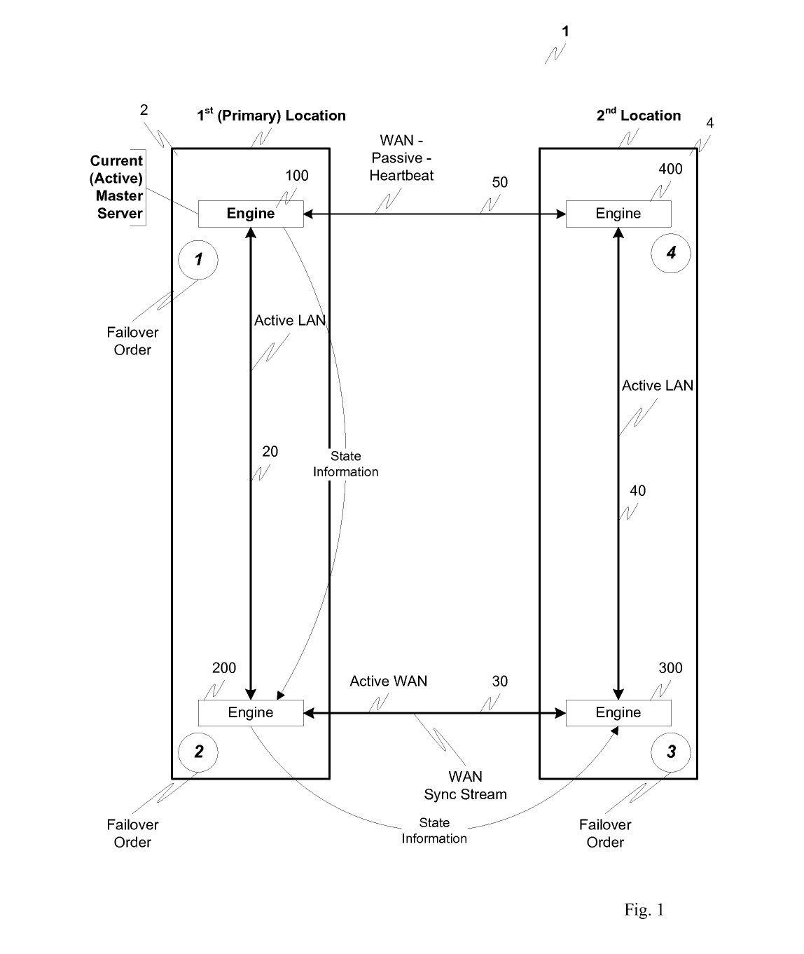

FIG. 1 illustrates an exemplary architecture 1 with a geo-redundant hot-standby configuration. In particular, the architecture 1 includes, in a first or primary location, a first engine 100 and a second engine 200 connected via an active LAN link 20. The architecture 1 also includes, in a second location, a third engine 300 and a fourth engine 400 connected via an active LAN link 40. The engine 100 and engine 400 are connected via a WAN 50 that is passive and optionally carries a heartbeat communication. The engine 200 and engine 300 are connected via an active WAN link 30.

While an exemplary embodiment will be discussed in relation to a call center type of implementation, it should be appreciated that while elements 100-400 are referred to as “engines”, these can be any systems or computers such as servers, or the like, where true geo-redundancy and hot-standby services are desired. Moreover, it should be appreciated that in this exemplary implementation, the first or primary location is geographically separated from the second location where the first and second locations can connect via one or more wide area networks (WANs). For ease of illustration, only four links have been illustrated in this exemplary architecture, however, it should appreciated that additional links could also be utilized and/or shared to assist with the interconnection of the various components. In general, any one or more links connecting any one or more of the various components illustrated in architecture 1 could also be used with the techniques disclosed herein.

As illustrated in the exemplary architecture 1 in FIG. 1, there is a current (active) master server or engine 100, connected via link 20, which is an active LAN link, to engine 200. In this exemplary embodiment, the active master 100 is the single active master for the entire architecture 1, making all the decisions regarding call management and routing. Engine 200, connected via the active LAN link 20, which could be a high bandwidth link to the active master 100, has a primary role of keeping the remote center, here the second location 4, synchronized with the active master 100.

In this exemplary embodiment, the active LAN link 20, and active LAN link 30, as well as the active LAN link 40 are all higher bandwidth links. However, the WAN link 50 can be passive in nature, and lower bandwidth for maintaining only, for example, a heartbeat between engine 100 and engine 400. This passive WAN link can be used to, for example, maintain the health of the system, and provide quick switching if, for example, one or more primary WAN links fail.

As a general overview, failover occurs in the order indicated where if engine 100 fails, engine 200 becomes the active master. Similarly, if engine 300 fails, engine 400 becomes the active master.

In a similar manner, if engine 200 is the active master, and a fail occurs, engine 300 becomes the active master. As indicated by the arrows in FIG. 1, engine 200, based on the state information forwarded from engine 100 keeps engine 300 synchronized, via the forwarding of state information, while engine 100 is the active master. If engine 200 were the active master, engine 300 would receive state information, with engine 300 acting as a “follower” doing all the work to assure high availability of the architecture.

More specifically, the “following” engine maintains synchronization based on state information received from the active master. As discussed hereinafter, bit vectoring can be used for synchronization with the bit stream carrying the state information being compressible before it is sent from the active master to the “following” engine. It should be appreciated, however, that this bit stream can be in any format including, for example, a UDP packet, a datagram, or in general any internet protocol or arrangement of information that is capable of carrying the state information between one or more servers.

As discussed above, the data stream between servers should be efficient. The status of resources can be shared by a bit vector to assist with this efficiency. Information that can be included regarding the status of resources and the state information can include one or more of eligibility, status information, state information, which can include one or more of resource information, work information, service information, store information, entity information, group information, and the like, with the state information optionally being dynamic, admin information that generally manages properties, and metrics for any one or more of the above types of information, that can also be relationship-based metrics. As will be appreciated, maintaining synchronization of this information for a very busy call center that has, for example, a one million call-per-hour workload can be challenging.

In some embodiments, each engine 100, 200, 300, 400 may be connected to some or all other engines for purposes of analyzing health of the other engines. These connections may be established directly or indirectly and the health information may be transmitted in either a pull or push fashion.

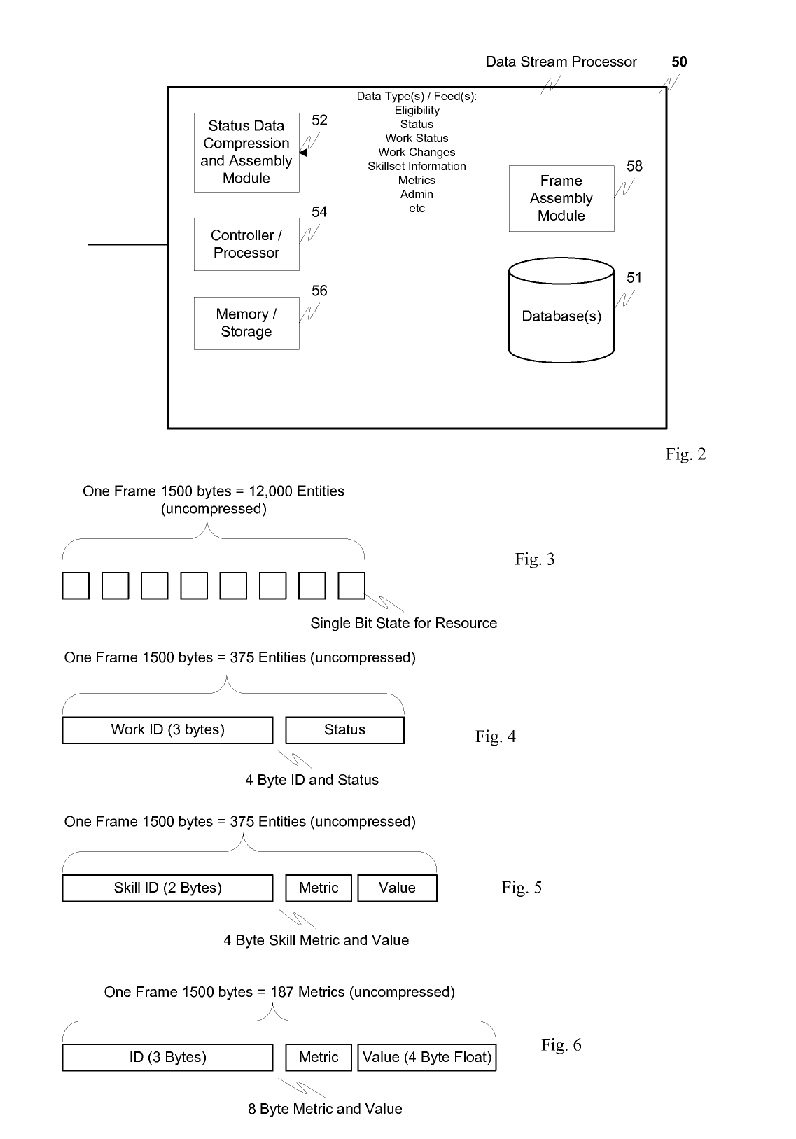

Accordingly, an exemplary aspect of this invention, in cooperation with the data stream processor illustrated in FIG. 2, is capable of utilizing intelligent compression to share data between the servers at one or more sites.

More specifically, the data stream processor in FIG. 2 can be associated with any one or more of the components in FIG. 1 and includes, for example, a status data compression and assembly module 52, controller/processor 54, memory/storage 56, frame assembly module 58 and database 51.

The data stream processor 50 and its associated functionality can be shared by one or more of the servers/engines in the architecture 1 depicted in FIG. 1. Additionally, a data stream processor 50 can be associated with each server/engine illustrated in FIG. 1, as appropriate. The data stream processor 50 manages the data stream between servers to ensure efficiencies, to perform intelligent (dynamic) compression and to assemble state information as discussed herein below. The status data compression assembly module 52 receives one or more data types/feeds as depicted in FIG. 2 and assembles this information for transmission to one or more “following” servers or engines in cooperation with the frame assembly module 58, controller 54 and memory 56.

As discussed, the status of resources can be shared by a bit vector. Any type of information associated with the underlying architecture can be exchanged between the various servers, with for example in a call center type of environment, typical status information being directed toward eligibility information, status information, state information, administrative information and metrics. As illustrated in FIG. 3, a single bit state can be used to represent the status of a resource. In this particular exemplary embodiment, one frame of 1500 bytes in uncompressed form can equate to representing 12,000 entities. If the data is compressed, the frame illustrated in FIG. 3 can hold, for example, information relating to approximately 50,000 agents in a single packet.

In FIG. 4, a frame is illustrated that represents the work status or changes to entities such a skillset. In this exemplary embodiment, there is a three-byte Work ID and a Status field, with the combination being four bytes. Therefore, one frame of 1500 bytes can represent 375 entities in uncompressed form.

FIG. 5 illustrates an exemplary frame that represents skillsets and metrics that are updated in blocks (short case). More specifically, as illustrated in FIG. 5, one frame of 1500 bytes is equal to 375 entities in uncompressed format, with the Skill ID being two bites, and the Metric and Value being represented by one byte each.

In FIG. 6, for metrics that are floating point and can't be enumerated or normalized in one byte, they can be sent in accordance with one exemplary embodiment in a large metric frame, where, for this particular embodiment, one frame of 1500 bytes is equal to 187 metrics in uncompressed form. There is a combination of 8 bytes used with 3 bytes used for the ID, one byte for the Metric, and four bites by the Value of that metric.

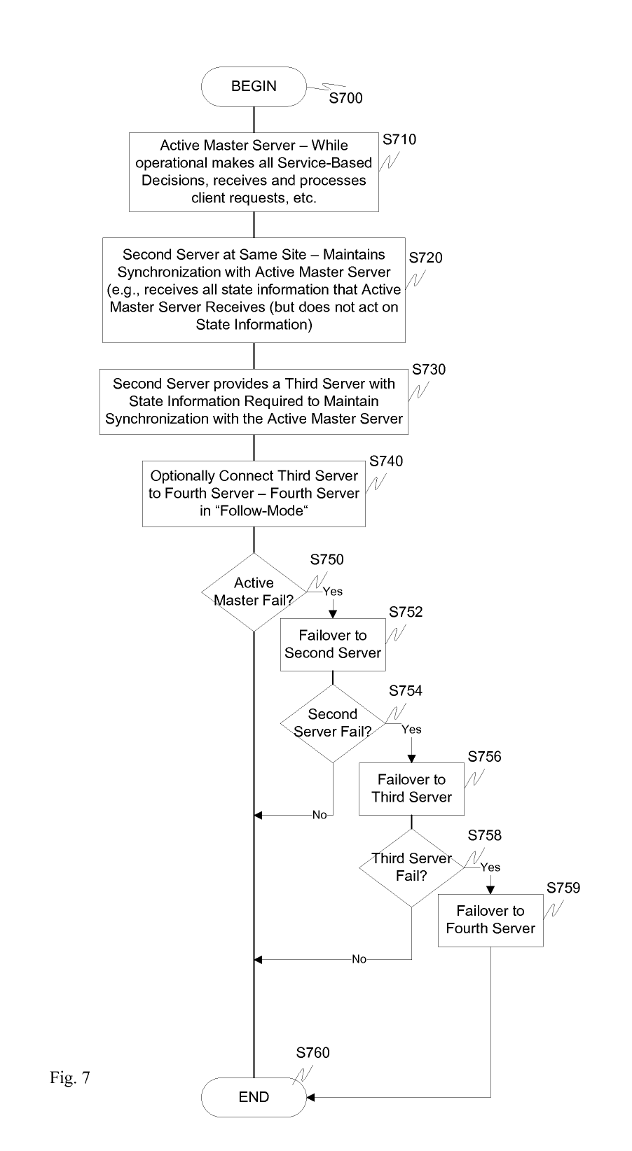

FIG. 7 outlines an exemplary failover method for a server architecture, such as that illustrated in FIG. 1. In particular, control begins in step S700 and continues to step S710. In step S710, the active master server, while operational, makes all service-based decisions, receives and processes client requests, and the like. Next, is step S720, a second server at the same site maintains synchronization with the active master server and receives all state information that the active master server receives, but this second server does not act on that information. Then, step S730, the second server provides a third server what is required to maintain synchronization with active master server. Control then continues with step S740.

In step S740, a third server can optionally be connected to a fourth or additional server, with the fourth server operating in “follow-mode”. Next, in step S750, a determination is made whether the active master has failed. If the active master has failed, control jumps to step 752 with control otherwise continuing to step S760.

In step S752, the architecture fails over to the second server, with the second server now becoming the active master and forwarding state information to the third server. In step S754 a determination is made whether the second server has failed. If the second server has failed, control continues to step S756 with control otherwise jumping to step S760.

In step S756, when the second server fails, it fails over to the third server, with the third server sending state information to the fourth server, which is then operating in follow mode. Next, in step S758, a determination is made whether the third server has failed. If the third server has failed, control continues to step S759 with control otherwise jumping to step S760. In step 759, the fourth server becomes the active master with another designated server being designated to operate in a follow mode, and received the state information from the fourth server, which is now the active master. This process can continue based on the number of servers and the architecture that are setup for failover operation.

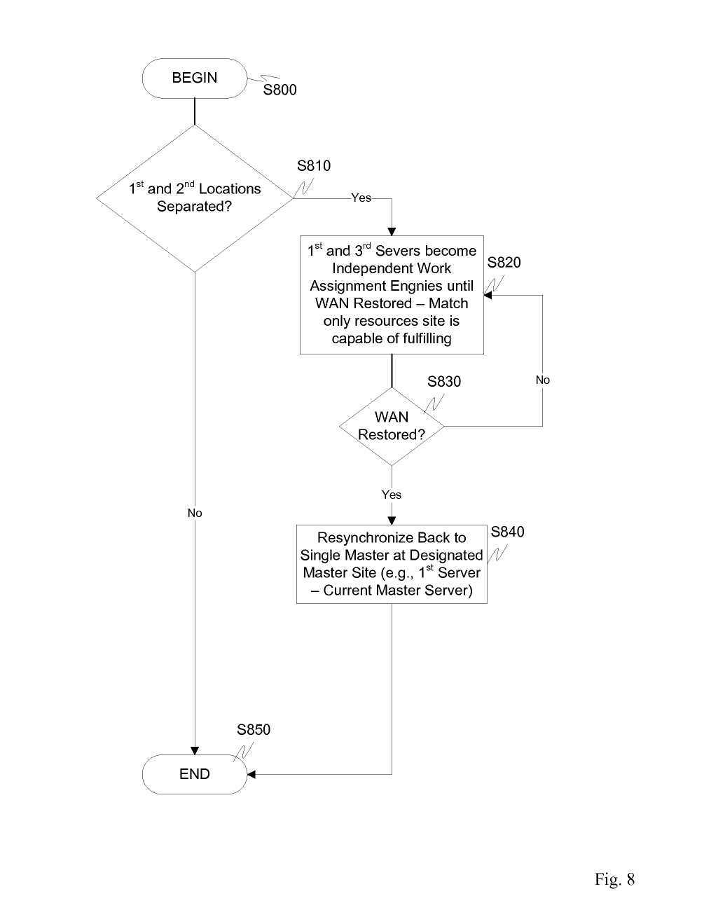

FIG. 8 outlines an exemplary method to address the contingency when the first and the second geographically separated locations become separated. In particular, control begins in step S800 and continues to step S810. In step S810, a determination is made as to whether the first and second locations have been separated. As will be appreciated, this determination can be expanded to any number of geographically separated locations as appropriate for the particular implementation. If the first locations are not separated control jumps to step S850 where the control sequence ends.

Otherwise, control continues to step S820. In step S820, the first and third servers become independent matchmakers and are “active masters” and remain in this state until the WAN connection(s) that connects the first and second locations has been restored. During this operational mode, the first and third active servers match only resources that are capable of being fulfilled within the respective location. Next, in step S830, a determination is made as to whether or not the WAN has been restored. If the WAN has been restored, control continues to step S840 with control otherwise jumping back to step S820.

In step 840, the architecture is resynchronized back to a single master configuration, where the single master is at the site designated as the master site with, for example, reference to FIG. 1, engine 1 being designated as the active or master server at the master site. Normal operation then commences with control continuing to step S850 where the control sequence ends.

While the above-described flowchart has been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the computer and network arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for determining the availability, reliability, and/or provisioning of a particular network based on a failure within the network. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A geo-redundant server architecture comprising:
a first server at a primary location;
a second server at the primary location; and
a third server at a secondary, geographically remote, location, the first and second servers being connected by a local area network and the second and third servers being connected by a wide area network, wherein the first server makes service-based decisions, the second server maintains synchronization with the first server and the second server provides the third server with state information for synchronization with the first server.

2. The architecture of claim 1, wherein the first server is an active master server and forwards state information to the second server via the local area network.

3. The architecture of claim 1, wherein the wide area network carries synchronization information between the second server and the third server.

4. The architecture of claim 1, wherein failover order is from the first server to the second server to the third server.

5. The architecture of claim 1, further comprising a fourth server at the secondary connection that maintains a heartbeat with the first server.

6. The architecture of claim 1, further comprising one or more data stream processors adapted to dynamically compress and assemble status information.

7. The architecture of claim 1, wherein the status of resources between servers are shared by a bit vector.

8. The architecture of claim 1, wherein the architecture uses the second and third servers at each location to offload the compression from the first server.

9. The architecture of claim 1, wherein the architecture vectorizes status data into frames that can be compressed and does not use difference updates.

10. The architecture of claim 1, wherein synchronization processing is offloaded to a non-active server.

11. A method for operating a geo-redundant server architecture comprising:
designating a first server at a primary location as a master server;
designating a second server at the primary location as a first failover server; and
designating a third server at a secondary, geographically remote, location as a second failover server, wherein the first and second servers are connected by a local area network and the second and third servers are connected by a wide area network, wherein the first server makes service-based decisions, the second server maintains synchronization with the first server and the second server provides the third server with state information for synchronization with the first server.

12. The method of claim 11, wherein the first server is the active master server which forwards state information to the second server via the local area network.

13. The method of claim 11, wherein the wide area network carries synchronization information between the second server and the third server.

14. The method of claim 11, wherein failover order is from the first server to the second server to the third server.

15. The method of claim 11, further comprising maintaining a heartbeat between a fourth server at the secondary connection and the first server.

16. The method of claim 11, further comprising dynamically compressing and assembling status information.

17. The method of claim 11, wherein the status of resources between servers are shared by a bit vector.

18. The method of claim 11, wherein the architecture uses the second and third servers at each location to offload the compression from the first server.

19. The method of claim 11, wherein the architecture vectorizes status data into frames that can be compressed and does not use difference updates.

20. The method of claim 11, wherein synchronization processing is offloaded to a non-active server.
